(19) United States
(12) Patent Application Publication
(10) Pub. No.: US 2014/0222802 A1
(43) Pub. Date: Aug. 7, 2014

(54) SELECTING SOCIAL CONTEXT FOR SPONSORED STORIES IN A SOCIAL NETWORKING SYSTEM

(71) Applicant: Facebook, Inc., Menlo Park, CA (US)

(72) Inventors: Rong Yan, Mountain View, CA (US); Eytan Bakshy, San Francisco, CA (US); Hao Zhang, Fremont, CA (US); Huajing Li, Sunnyvale, CA (US)

(73) Assignee: Facebook, Inc., Menlo Park, CA (US)

(21) Appl. No.: 13/759,838

(22) Filed: Feb. 5, 2013

(51) Int. Cl. G06F 17/30

(52) U.S. Cl. CPC G06F 17/3053; G06F 17/30554
USPC 707/727; 707/723

(57) ABSTRACT

A viewing user is provided with sponsored stories describes actions of a user connected to the viewing user associated with an object promoted by an advertiser or actions otherwise promoted by the advertiser. Based on a performance metric, the social networking system selects the user or action to be described by the sponsored story. For example, the social networking system ranks candidate sponsored stories describing different actions or users and selects a candidate sponsored story to increase the likelihood of a viewing user interacting with the selected candidate sponsored story.

### BACKGROUND

This invention generally pertains to social networking systems, and in particular to optimizing sponsored stories presented by a social network system.

Social networks, or social utilities that track and enable connections between users (including people, businesses, and other entities), have become prevalent in recent years. These social networking systems allow users to communicate information more efficiently. For example, a social networking system user may post contact information, background information, job information, hobbies, and/or other user-specific data to a location associated with the user on a social networking system. Other users can then review the posted data by browsing user profiles or searching for profiles including specific data. Social networking systems also allow users to associate themselves with other users, creating a web of connections among the users of the social networking system. These connections among the users can be leveraged by the social networking system to provide more relevant information to each user in view of user-specific interests.

Social networking systems typically include a system for connecting users to content most likely to be relevant to different users. For example, a social networking system may group users according to one or more common attributes in their profiles, such as geographic location, employer, job type, age, music preferences, interests, or other attributes. Users of the social networking system or external parties, such as advertisers, can then use these groups to customize information delivery based on properties of the groups to increase the likelihood that users in a group receive information of interest.

Advertisers have attempted to leverage information about social networking system users by using information from the social networking system to target advertisements (“ads”) to different users. Commonly, an advertiser identifies user characteristics to the social networking system, which identifies users having one or more of the characteristics and serves an ad from the advertiser to the users having at least one of the characteristics. For example, an advertiser identifies users with an affinity for a band and a location near a venue where the band is performing, and the social networking system presents advertisements for the band's concert to users having the identified information in their profiles. However, this use of targeting criteria does not leverage the connections between social networking system users.

### SUMMARY

Embodiments of the invention optimize the communication of sponsored story units, which include a sponsored story and/or one or more related posts or activities. The sponsored story describes an action taken by a user of a social networking system to whom the viewing user is connected and an object on which the action was taken. For example, the sponsored story may indicate that a particular user listened to an identified song or that the particular user shared a particular link. Hence, a sponsored story leverages information stored by the social networking system about objects in the social networking system and actions performed on various objects. For example, if a viewing user is connected to another user who has “liked” a company's fan page, the sponsored story provided to the viewing user may indicate that the other user has “liked” the page.

The performance of sponsored stories can be measured using various metrics, such as impressions, reach, user conversions, and/or revenue for sponsors. The social information to be included in a sponsored story is selected to make the sponsored story more relevant and interesting to the targeting users. For example, various types of social context information may be selected for the sponsored story, such as another user, an object, or a type of action that is identified in the sponsored story. The criteria used to select the sponsored story and/or other actions taken to modify the sponsored story presented to the viewing user may also be selected to interest users more so that one or more of the metrics for the sponsored story can be improved. To improve the metrics for the sponsored story, the performance data of previously presented sponsored stories are collected and analyzed, allowing advertisers or the social networking system to modify selection of sponsored stories.

In one embodiment, the social networking system receives a request for a sponsored story to present to a viewing user and identifies objects for inclusion in the sponsored story. For example, the social networking system identifies users connected to the viewing user, interactions performed by the identified users, and objects associated with the identified interactions. From the identified users, interactions, and objects, one or more candidate sponsored stories are generated. The candidate sponsored stories are ranked based on one or more criteria. For example, affinities between the viewing user and each candidate sponsored story are generated based on the interacting user and/or based on the object included in the candidate sponsored story, the types of objects included in the candidate sponsored story, and any other suitable criteria. Based on the ranking, a candidate sponsored story is selected and presented to the viewing user.

One or more performance metrics associated with the selected candidate sponsored story are captured. Performance metrics of various sponsored stories are analyzed and used to modify subsequent selection of sponsored stories to the viewing user. For example, an additional sponsored is selected based on one or more of the users in previous sponsored stories connected to the viewing user, the viewing user's interactions with an object in the subsequently selected sponsored story, the viewing user's affinity for an object or a user in the subsequently selected sponsored story, a recency of the object included in the subsequently selected sponsored story, a type of object included in the subsequently selected sponsored story, a content of an object included in the subsequently selected sponsored story, or any other suitable criteria. Sponsored stories may be regenerated and re-ranked based on analysis of performance metrics to improve sponsored story selection.

### BRIEF DESCRIPTION OF THE DRAWINGS

FIG. 1 is a block diagram of a process for generating sponsored stories in a social networking system, in accordance with one embodiment.

FIG. 2 is a block diagram of a system environment suitable, in accordance with one embodiment.

FIG. 3 is an example of a sponsored story unit displayed to a viewing user, in accordance with an embodiment.

FIG. 4 is a flowchart of a process for sponsored story optimization in a social networking system, in accordance with an embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

A social networking system offers its users the ability to communicate and interact with other users of the system. In use, users join the social networking system and then add connections to a number of other users to whom they desire to be connected. As used herein, the term “friend” refers to any other user to whom a user has formed a connection, association, or relationship via the system. Connections may be added explicitly by a user, for example, the user may select a particular other user to be a friend, or may be automatically created by the social networking site based on common characteristics of the users (e.g., users who are alumni of the same educational institution). Connections in social networking systems are usually in both directions, but need not be, so the terms “user” and “friend” depend on the frame of reference. For example, if Bob and Joe are both users and connected to each other in the system, Bob and Joe are also each other's friends. The connection between users may be a direct connection; however, some embodiments of a social networking system allow the connection to be indirect via one or more levels of connections. Also, the term “friend” need not require that users actually be friends in real life, (which would generally be the case when one of the users is a business or other entity); it simply implies a connection in the social networking system.

In addition to interactions with other users, the social networking system provides users with the ability to interact with various types of objects supported by the social networking system. An object may represent a variety of things, including, without limitation, profiles, applications (e.g., games playable within the social networking system), events (e.g., a representation of a concert that users may attend), groups (e.g., a page to which user may belong), entity based pages or hubs (e.g., a page constituting a particular entity's presence on the social networking system), locations associated with a user (e.g., “Palo Alto, Calif., USA”), advertisements (e.g., a page including advertising content), user-generated content items (e.g., user posts), representations of physical or digital items, concepts, etc. Objects may also be defined by a third party outside of the social networking system. For example, a web page domain host may define an object and an action on the social networking object such that a user's interaction with the object on the web page may be registered with the social networking system.

A user may establish a connection to an object in the social networking system or perform other interactions with an object via the social networking system. For example, a user may join a group, attend an event, check-in to a location, become a fan of a page, express a preference for an object (“like” the object), post content to a page, or perform any other action. An action may also be generation of content by the user for presentation by the social networking system. For example, a user may post data, such as comments on an entity's fan page. Users may also perform actions on objects outside of a domain associated with the social networking system. For example, a user may read an article on a newspaper domain, listen to a song on a music application, “like” a web page maintained by a domain other than that associated with the social networking system, etc. Many other types of actions between users and objects inside or outside of the social networking system are possible.

The social networking system includes one or more data stores including data describing actions performed by its users on objects maintained by the social networking system. Stored actions may be associated with a user profile, maintained by the social networking system, of a user performing the action. Additionally, the social networking system associates a stored action with an object on which the action was performed and stores the association, allowing subsequent retrieval of actions performed by social networking system users on various objects.

The social networking system presents a variety of content to its users. Examples of content that may be displayed to a user include images, videos, audio data, pictures, etc. Additionally, the social networking system may display a newsfeed to its users. The newsfeed includes stories describing actions taken by social networking system users on objects maintained by the social networking system. For example, a newsfeed presented to a viewing user includes stories describing actions performed on objects by other users connected to the viewing user. When selecting stories for inclusion in a newsfeed, the social networking system may use a variety of factors. In one embodiment, advertisers may provide the social networking system with compensation for including stories selected by the advertiser in the newsfeed. This allows the advertiser to “sponsor” stories to increase the likelihood that the stories are presented to social networking system users. For example, a sponsored story can report that a friend of the viewing user has “liked” a social networking object, commented on the object, reviewed the object, asked a question regarding the object, associated text or media with the object, and/or the like. Hence, sponsoring a story allows advertisers to increase the likelihood that users view the story by providing the social networking system with an incentive to present sponsored stories to users.

Hence the social networking system provides one or more sponsored story units for display to a viewing user in the viewing user's newsfeed. In addition to the newsfeed, the sponsored stories may be presented to the viewing user in any other portion of a user interface displayed to the viewing user, such as on the right-hand side of the web page, the logout page, or inside typeahead. The sponsored story unit includes a sponsored story describing one or more actions performed on an object by one or more users connected to the viewing user and may also include additional information associated with the object. For example, a sponsored story indicates that a viewing user's friend listened to a song, read an article or performed another type of action. Embodiments of sponsored stories, or social ads, are described in U.S. application Ser. No. 12/193,702, filed Aug. 18, 2008, published as U.S. Patent Application Publication No. 2009/0119167, which is incorporated in its entirety be reference herein.

A sponsored story may include a post associated with an object involved in the interaction described by the sponsored story. For example, a user connected to a user viewing a sponsored story (a “viewing user”) may have expressed a preference for a page associated with a company (“liked” the page). The sponsored story describes the user liking the page and may also include a comment associated with the page (a “post” associated with the page). A post may be any type of data supported by the social networking system and may be associated with an object in a variety of ways. Examples of posts include text, images, video, audio, links, applications, and/or the like. Additionally a post included in a sponsored story may be generated by any social networking system user. For example, the post may be generated by the user performing the action described by the sponsored story or may be generated by another social networking system user. Thus, a sponsored story may include information indicating that a user connected to the viewing user has “liked” the fan page of a particular online retailer and a comment posted to the fan page by a different user.

Including posts in a sponsored story allows a viewing user to better understand context behind the interaction described by the sponsored story. For example, a user connected to the viewing user “likes” a page of an automobile company, and including comments from other users about the automobile company allows the viewing user to better understand the reason for the interaction in the sponsored story. This additional context may increase the likelihood of the viewing user interacting with the sponsored story.

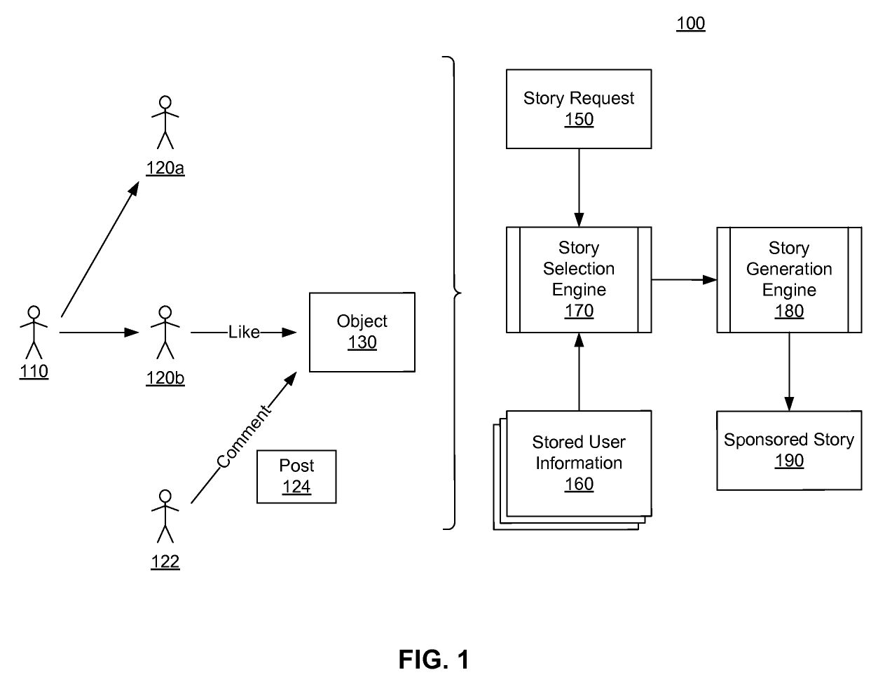

FIG. 1 is a block diagram of one embodiment of sponsored story generation in a social networking system 100 showing the generation of a sponsored story in a social networking system 100, in a social networking system, in accordance with one embodiment. As shown in FIG. 1, a story selection engine 170 receives a request 150 to present a sponsored story 190 to a viewing user 110 of the social networking system 100. The request 150 may be received from an advertiser. Upon receiving the story request, the story selection engine 170 searches stored user information 160 for users, objects, interactions, and historical stories for generating the requested sponsored story. In one embodiment, the sponsored story 190 is generated from previously presented sponsored stories. For example, an interaction or objects described in previously presented sponsored story may be selected for description by the sponsored story 190. The story selection engine 170 may determine whether users 120a, 120b connected to the viewing user 110 have performed an interaction described by a previously presented sponsored story or interacted with an object described in a previously presented sponsored story.

If a user 120, 120b connected to the viewing user 110 performs a specified type of interaction or interacts with a specified object, the story selection engine 170 selects the interaction by the user 120a, 120 connected to the viewing user 110 as the basis for the sponsored story 190. For example, a previously presented sponsored story describes a “like” type interaction with an object 130. In FIG. 1, user 120b has “liked” the object 130, so the story selection engine 170 may select the “like” type interaction and user 120b as the basis for the sponsored story 190.

The story selection engine 170 may further identify one or more candidate posts 124 for inclusion in the sponsored story 190. In one embodiment, the candidate posts 124 are associated with the object 130 described by the sponsored story 190. A candidate post 124 may be generated by a user 122 that is not connected to the viewing user 110. In the example of FIG. 1, the candidate post 124 is associated with user 122, which is not connected to the viewing user 110. The story selection engine 170 may select a candidate post 124 for inclusion in the sponsored story 109. A story generation engine 180 generates the sponsored story 190 from the user, interaction, object, and/or candidate post 124 provided by the story selection engine 170. The sponsored story 190 describes the interaction and identifies the user and/or object associated with the interaction. In some embodiments, the sponsored story also includes the candidate post 124 selected by the story selection engine 170.

### System Architecture

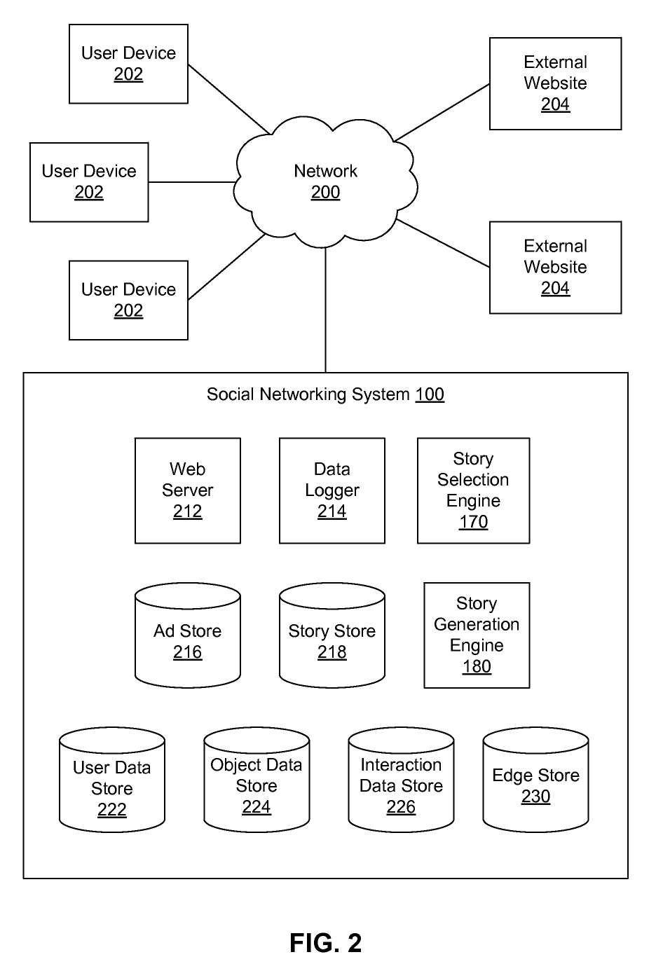

FIG. 2 is a block diagram of one embodiment of a system environment for sponsored story generation. The system environment comprises a network 200, one or more user devices 202, one or more external websites 204, and the social networking system 100. While three user devices and two external website are shown in FIG. 2, it should be appreciated that any number of these entities (including millions) can be included. In alternative configurations, different entities can also be included in the system.

A user device 202 is a computing device capable of processing data, receiving input from a user, as well as transmitting and receiving data via the network 200. In one embodiment, a user device 202 is a conventional computer system executing an operating system. In another embodiment, the user device 202 may be any device having computer functionality, such as a personal digital assistant (PDA), mobile telephone, smart-phone, etc. In one embodiment, the user device 202 executes an application, such as a browser application, allowing a user of the user device 202 to interact with the social networking system 100. In another embodiment, the user device 202 interacts with the social networking system 100 through an application programming interface (API) that runs on a native operating system of the user device 202, such as IOS® or ANDROID™.

The user devices 202 are configured to communicate via a network 200, which may comprise any combination of local area and/or wide area networks, using both wired and wireless communication systems. In one embodiment, the network 200 uses standard communications technologies and/or protocols. Thus, the network 200 may include communication links using technologies such as Ethernet, 802.11, worldwide interoperability for microwave access (WiMAX), 3G, 4G, code division multiple access (CDMA), digital subscriber line (DSL), etc. Similarly, the networking protocols used on the network 120 may include multiprotocol label switching (MPLS), transmission control protocol/Internet protocol (TCP/IP), User Datagram Protocol (UDP), hypertext transport protocol (HTTP), simple mail transfer protocol (SMTP) and file transfer protocol (FTP). Data exchanged over the network 120 may be represented using technologies and/or formats including hypertext markup language (HTML) or extensible markup language (XML). In addition, all or some of the communication links may be encrypted using conventional encryption technologies such as secure sockets layer (SSL), transport layer security (TLS), and Internet Protocol security (IPsec). One or more external websites 204 may be coupled to the network 200 for communicating with the social networking system 100, which is further described below.

The social networking system 100 is a computing system that allows users to communicate or otherwise interact with each other and access content. As illustrated in FIG. 2, the social networking system 100 includes a web server 212, a data logger 214, a story selection engine 170, a story generation engine 180, an advertisement (“ad”) store 216, a story store 218, a user data store 222, an object data store 224, an interaction data store 226, and an edge store 230. In alternative configurations, fewer or more and/or different components can be included in the system 100.

Each user of the social networking system 100 is associated with a user profile, which is stored in the user data store 222. User account information, such as a unique user identification (ID), a login name and password, and other related information for a user are stored in the user data store 222. In one embodiment, the user account information is indexed by the user ID or by other suitable information. A user profile includes declarative information about the user that was explicitly shared by the user, and may also include profile information inferred by the social networking system 100. In one embodiment, a user profile includes multiple data fields, each data field describing one or more attributes of the corresponding user of the social networking system 100. The user profile information stored in user data store 222 describes the users of the social networking system 100, including biographic, demographic, and other types of descriptive information, such as work experience, educational history, gender, hobbies or preferences, location and the like. A user profile may also store other information provided by the user, for example, images or videos. In certain embodiments, images of users may be tagged with identification information of users of the social networking system 100 displayed in an image. A user profile in the user data store 222 may also maintain references to actions by the corresponding user performed on content items in the object data store 224 and stored in the interaction data store 226.

While user profiles in the user data store 222 are frequently associated with individuals, allowing people to interact with each other via the social networking system 100, user profiles may also be stored for entities such as businesses or organizations. This allows an entity to establish a presence on the social networking system 100 for connecting and exchanging content with other social networking system users. The entity may post information about itself, about its products or provide other information to users of the social networking system using a brand page associated with the entity's user profile. Other users of the social networking system may connect to the brand page to receive information posted to the brand page or to receive information from the brand page. A user profile associated with the brand page may include information about the entity itself, providing users with background or informational data about the entity.

The object data store 224 stores objects representing various types of content. Examples of content represented by an object include a page post, a status update, a photo, a video, a link, a shared content item, a gaming application achievement, a check-in event at a local business, a brand page, or any other type of content. Objects may be created by users of the social networking system 100, such as status updates, photos tagged by users to be associated with other objects in the social networking system, events, groups or applications. In some embodiments, objects are received from third-party applications or third-party applications separate from the social networking system 100. Content “items” represent single pieces of content that are represented as objects in the social networking system 100. Users of the social networking system 100 are encouraged to communicate with each other by posting text and content items of various types of media through various communication channels, increasing the interaction of users with each other and increasing the frequency with which users interact within the social networking system 100.

The data logger 214 receives communications about user actions on and/or off the social networking system 100 and populates the interaction data store 226 with information describing user actions. Such actions may include, for example, adding a connection to another user, sending a message to another user, uploading an image, reading a message from another user, viewing content associated with another user, attending an event posted by another user, among others. In addition, a number of actions described in connection with other objects are directed at particular users, so these actions are associated with those users as well. These actions are stored in the interaction data store 226.

The interaction data store 226 may be used by the social networking system 100 to track user actions on the social networking system 100, as well as external website that communicate information to the social networking system 100. Users may interact with various objects on the social networking system 100, including commenting on posts, sharing links, and checking-in to physical locations via a mobile device, accessing content items or other interactions. Information describing these actions is stored in the interaction data store 226. Additional examples of interactions with objects on the social networking system 100 included in the interaction data store 226 include commenting on a photo album, communications between users, becoming a fan of a musician, adding an event to a calendar, joining a groups, becoming a fan of a brand page, creating an event, authorizing an application, using an application and engaging in a transaction. Additionally, the interaction data store 226 records a user's interactions with content on the social networking system 100 as well as other applications operating on the social networking system 100. In some embodiments, data from the interaction data store 226 is used to infer interests or preferences of the user, augmenting the interests included in the user profile and allowing a more complete understanding of user preferences.

In one embodiment, an edge store 230 stores the information describing connections between users and other objects on the social networking system 100 in edge objects. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 100, such as expressing interest in a page on the social networking system, sharing a link with other users of the social networking system, and commenting on posts made by other users of the social networking system.

The edge store 230 stores edge objects that include information about the edge, such as affinity scores for objects, interests, and other users. Affinity scores may be computed by the social networking system 100 over time to approximate a user's affinity for an object, interest, and other users in the social networking system 100 based on the actions performed by the user. A user's affinity may be computed by the social networking system 100 over time to approximate a user's affinity for an object, interest, and other users in the social networking system 100 based on the actions performed by the user. Computation of affinity is further described in U.S. patent application Ser. No. 12/978,265, filed on Dec. 23, 2010, which is hereby incorporated by reference in its entirety. Multiple interactions between a user and a specific object may be stored in one edge object in the edge store 230, in one embodiment. In some embodiments, connections between users may be stored in the user data store 222, or the user data store 222 may access the edge store 230 to determine connections between users.

The web server 212 links the social networking system 100 via the network 200 to one or more user devices 202, as well as to one or more external websites 204. The web server 212 serves web pages, as well as other web-related content, such as JAVA®, FLASH®, XML and so forth. The web server 212 may provide the functionality of receiving and routing messages between the social networking system 100 and the user devices 202, for example, instant messages, queued messages (e.g., email), text and SMS (short message service) messages, or messages sent using any other suitable messaging technique. A user may send a request to the web server 212 to upload information, for example, images or videos that are stored in the content store 222. Additionally, the web server 212 may provide API functionality to send data directly to native client device operating systems, such as IOS®, ANDROID™, WEBOS® or RIM.

The ad store 216 stores a plurality of ads received from advertisers or other entities. In addition, the ad store 216 may store ad tags associated with ads. An ad tag identifies or otherwise describes the subject matter of the ad, the genre of the ad, the product or service represented by the ad, or any other characteristic of the ad. In some embodiments, the ad tags identify specific social networking system objects which may be related to the ad.

The story selection engine 170 receives requests for presenting a sponsored story to a viewing user of the social networking system 100 and selects stored information for generating a sponsored story. In one embodiment, the story selection engine optimizes selection of data for sponsored story generation based on information in the request or analysis of sponsored stories previously presented to a user. The request for a sponsored story may be received from any suitable source, such as an advertiser, an advertising broker, or executable code embedded within an advertisement selected from the ad store 216.

To generate a sponsored story, the story selection engine 170 identifies data from the user data store 222, the object data store 224, and the interaction data store 226. Data from the edge story 230 is also accessed to identify users from the user data store 222 connected to the viewing user. Data identifying a user connected to the viewing user performing a type of interaction with an object or performing an interaction with a type of object is identified based on the content of the request. Additionally, candidate posts may be selected from the object data store 224 for inclusion in the sponsored story based on the request, as described above in conjunction with FIG. 1.

Objects may be identified in a variety of ways. In one embodiment, the request includes tags, such as ad tags from an advertisement used to identify particular objects with the social networking system 100. For instance, an ad tag may identify a fan page for a particular rock band by the URL for the fan page, a social network index number for the fan page, or key words within the social networking system. In an alternative embodiment, the request identifies an ad related to the sponsored story, and the selection engine 170 identifies objects related to the ad by a pre-designated index correlating ads to objects related to the ads. This pre-designated index may be populated by advertisers or any other party. For example, if the identity of the ad is provided, the social networking system 100 determines which objects have been identified previously as related to the ad, and uses this as a basis for identifying objects related to the ad. Alternatively, the story selection engine 170 identifies characteristics, properties, objects or any other features of an ad identified by the request or by the request. For example, the story selection engine 170 scans the text of an ad included in a request, identifies images in the ad included in the request, or identifying other characteristics of the ad. Objects having one or more characteristics matching or similar to the identified characteristics are identified by the story selection engine 170.

Users for inclusion in the sponsored story may also be selected in a variety of ways. For example, users having a type of connection with the viewing user specified by the request are identified by the story selection engine 170. As another example, users connected to the viewing user and having one or more characteristics specified by the request are identified embodiment. Users not explicitly connected to the viewing user but have another association with the viewing user may be identified. For example, users connected to a common user as the viewing user, users having common user profile information (the same favorite movie, attended the same high school, etc.), users that are members of the same group, or users having any other suitable characteristic are identified. Similarly, the story selection engine 170 may identify interactions by users in a variety of ways. For example, the story selection engine 170 identifies types of actions specified by the request or identifies actions occurring within a time interval specified by the request

As described above in conjunction with FIG. 1, posts may be included in the sponsored story to provide additional context for the action described by the sponsored story. The story selection engine 170 identifies candidate posts associated with an object for inclusion in the sponsored story from the object data store 224. A candidate post is associated with the object. For example, the story selection engine 170 identifies a page for inclusion in a sponsored story and retrieves comments or other content posted to the page. The candidate posts are also identified with users generating or providing the post, which may be identified in the sponsored story.

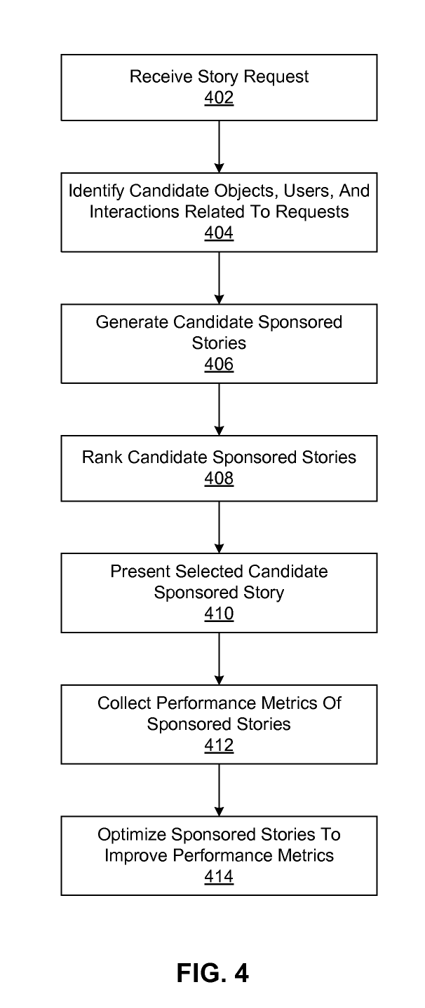

In one embodiment, the story selection engine 170 retrieves previously presented sponsored stories from the story store 218 to identify data for a requested sponsored story. The received previously presented sponsored stories may describe a specific action, object, or user identified by the request. Performance metrics may be included in the story store 218 and are retrieved along with the previously presented sponsored stories. As described below in conjunction with FIG. 4, the story selection engine 170 may analyze the performance metrics of the previously presented sponsored stories when selecting content for the requested sponsored story.

Based on the identified users, interactions, and/or posts, the story selection engine 170 selects information that is communicated to the story generation engine 180, which creates one or more sponsored stories from the information. For example, a sponsored story may indicate that two of the viewing user's friends have “liked” the fan page of a certain company. The generated sponsored story 190 may also include additional information stored in the social networking system, such as the name and a picture of the at least one of the viewing user's friends, links to the user profile of the at least one friend, questions and/or other content specified in the selected story request, etc. The generated sponsored story may be presented to the viewing user in a variety of ways. For example, the generated sponsored story is presented as a story in a newsfeed for the viewing user, a banner, a notification message, an interactive pop-up, or using any other suitable distribution method. In one embodiment, an advertisement from the ad store 216 is displayed along with the generated sponsored story. In one embodiment, the advertisement and the sponsored story may be formatted such that they appear as a single unit. In another embodiment, the advertisement and sponsored story may be presented on the same page but as discrete portions of content.

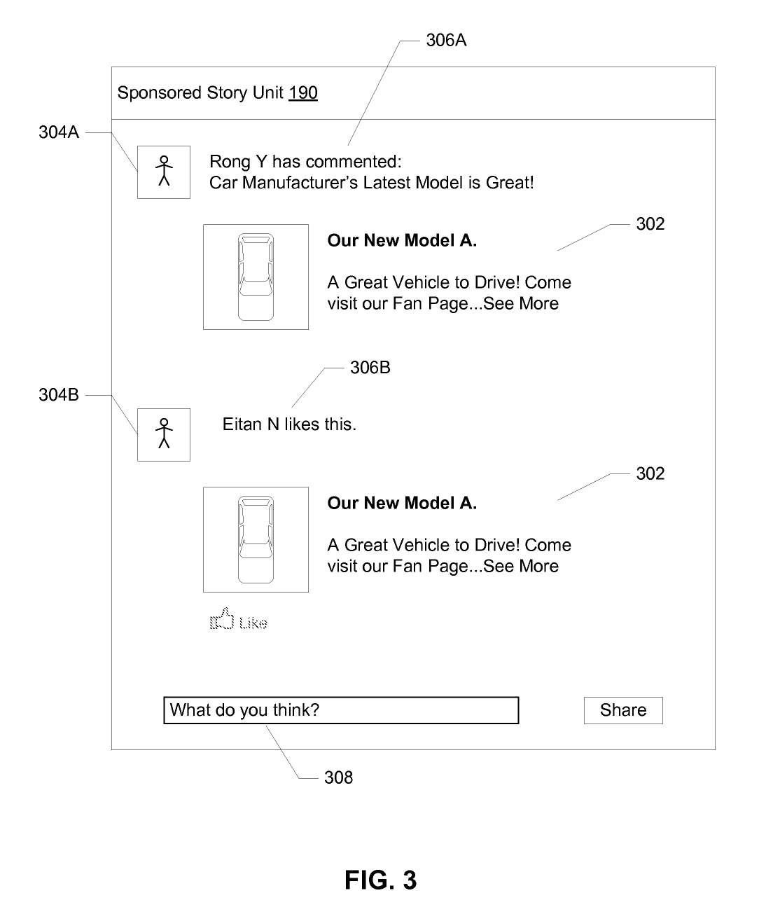

FIG. 3 is a sponsored story unit 190 displayed to a viewing user, in accordance with one embodiment. In the example of FIG. 3, the sponsored story unit 190 identifies an object 302, users 304A, 304B, and interactions performed by the users 304A, 304B involving the object 302. The sponsored story unit 190 indicates that user 304A has commented 306A on object 302, which is a post to a fan page for a car manufacturer and indicates that user 304B has liked 306B the object 302. The sponsored story 190 also identifies the object 302 additionally includes post 302 and an image of a vehicle posted to the fan page by the car manufacturer. The sponsored story 190 may include an input element 308 for receiving data from the viewing user for association with the sponsored story 190. In some embodiments, the user may specify privacy settings for data provided via the input element 308 to limit the visibility of the provided data to other users.

### Optimization of Sponsored Story Selection

As described above, multiple candidate users, objects, and interactions are retrieved when a request for a sponsored story is received. The story selection engine 170 generates and ranks a set of candidate sponsored stories from the candidate users, objects, and interactions. Various criteria may be used to rank the candidate stories to optimize an objective of the sponsored story. Example objectives of the sponsored story include: maximizing unique number or percentage of impressions (social reach), maximizing number or frequency of user conversions, maximizing click-through-rate, maximizing revenue for the sponsors and providers, and any combinations of the above metrics. To optimize the objective of the sponsored story, the story selection engine 170 may further modify parameters used for selecting a candidate sponsored story, presenting the selected sponsored story, and/or for generating candidate sponsored stories.

Advertisers or other content providers requesting a sponsored story may specify different models or parameters in the request to modify generation and selection of the sponsored story by the story selection engine 170. As described above, performance data of previously presented sponsored stories is stored in the story store 218, and the story selection engine 170 may retrieve this performance data, allowing an entity requesting a sponsored story to review performance data of previously presented sponsored stories, which may have been generated or presented based on different models and/or parameters. For example, by analysis and comparison, the requesting party may find out a better way to improve friend selection when generating sponsored story for a viewing user, a particular interaction type that promotes the product the best, or certain page post content attracts most attentions.

FIG. 4 is a flowchart of one embodiment of a process of optimizing selection of sponsored stories by a social networking system 100. The story selection engine 170 receives 402 a request to generate a sponsored story for presentation to a viewing user; the request includes information for generating the sponsored story. For example, the request specifies a type of action or a type of object to include in the sponsored story. Additionally, the request may identify an advertisement related to the sponsored story. The request also includes a parameter specifying an objective of the sponsored story. Example objective of the sponsored story include: maximizing unique number or percentage of impressions (social reach), maximizing number or frequency of user conversions, maximizing click-through-rate, maximizing revenue for the sponsors and providers, and any combinations of the above metrics. Based on information specified in the request, the story selection engine 170 identifies 404 objects, users, and interactions, as described above in conjunction with FIG. 2.

From the identified objects, users, and interactions, the story selection engine 170 generates one or more candidate sponsored stories. Each of the identified candidate sponsored stories describes an interaction by an identified user with an identified object. The story selection engine 170 ranks 408 the candidate sponsored stories based on various criteria, including the parameter specified by the request and performance scores of the sponsored stories, such as cost per click, cost per impression, conversion rate and any combinations thereof. In one embodiment, candidate sponsored stories are identified and ranked based on the objective parameter, their historical performance scores (e.g., the effective cost per thousand impressions), or a combination of the two factors. For example, to identify a target number of candidates, the story selection engine 170 first uses the demography, location and interests information of the user to filter all the sponsored stories based on the objective parameter. If more candidate sponsored stories than the specific number are identified, the story selection engine 170 then sorts the sponsored story based on their historical performance over a specific time period (e.g., the last 30 days) to select the top stories as candidates.

This allows the ranking 408 to be optimized for the objective of the sponsored story specified by the request. For example, the affinities between the viewing user and each candidate sponsored story are determined and the candidate sponsored stories are ranked 408 based on the affinities. An affinity may be a weighted function of the viewing user's estimated affinities to the object, the interaction, the friend, or any combination of the properties and features involved in a candidate sponsored story. The affinity represents a likelihood the viewing user will access or otherwise interact with the candidate sponsored story. Computation of affinity is further described in U.S. patent application Ser. No. 12/978,265, filed on Dec. 23, 2010, which is hereby incorporated by reference in its entirety. Rather than affinity for the sponsored story itself, the story generation engine 170 may rank 408 the candidate sponsored stories based on the affinities of the viewing user for a user described by each of the candidate sponsored stories.

Alternatively, the story generation engine 170 ranks 408 the candidate sponsored stories based on a type of interaction specified by the request. For example, candidate sponsored stories describing the specified type of interaction are ranked higher than candidate stories describing other types of interactions. In another embodiment, the story selection engine 170 ranks 408 candidate sponsored stories based on the user engagement with content of the candidate sponsored stories. User engagement value may be based on the number of social networking systems viewing or interacting with an object described by a candidate sponsored story. User engagement may be based on a specific type of interactions with the object (e.g., shares, expressions of preference, etc.), or on a variety of types of interactions with the object, by social networking system users. In another embodiment, the story selection engine 170 ranks 408 the candidate sponsored stories based on how recently interactions described by the candidate sponsored stories were performed. For example, candidate sponsored stories describing more recent interactions are ranked 408 higher than candidate sponsored stories describing older interactions.

The type and/or content of objects described by various candidate sponsored stories may be used to rank 408 the candidate sponsored stories. In one embodiment, candidate sponsored stories describing objects with characteristics matching characteristics in the viewing user's user profile have a high ranking. For example, a sponsored story on camping and hiking equipment ranks higher than a sponsored story regarding fishing gears for users with profiles indicating their interest in camping or hiking Various methods for ranking 408 candidate sponsored stories may be combined in any suitable manner.

From the ranking, the story selection engine 170 selects a sponsored story and communicates data describing the selected sponsored story to the story generation engine 180 which generates the sponsored story that is presented 410 to the viewing user. For example the highest ranked candidate sponsored story is selected and generated, or candidate sponsored stories having at least a threshold ranking are selected and generated. In one embodiment, different machine learning models for ranking 408 the candidate sponsored stories may be generated for different demographic subsets of users. Each model may be retrained at a different rate to ensure that the model reflects the latest information.

Additionally, after presentation of the sponsored story and presentation of other sponsored stories to other social networking system users, the story selection engine 170 collects 412 performance metrics of the presented sponsored stories, which are stored in the story store 218. Examples of the performance metrics include unique number or percentage of impressions (social reach), number and frequency of user conversions, click-through-rate, revenue for the sponsors and providers, and any combinations of these metrics. The collected performance metrics may be analyzed by the story selection engine 170 to identify user clicking/conversion patterns and improve 414 ranking performance and selection of subsequently requested sponsored stories. Based on the analysis, candidate sponsored stories may be regenerated and re-ranked when a request for another sponsored story is retrieved. The performance metrics may also be reported to the advertisers to give them the delivery insights.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
storing, in a social networking system, a user profile associated with a viewing user, the user profile identifying one or more users of the social networking system connected to the viewing user;
receiving a story request for a sponsored story unit, the story request identifying content to be included in the requested sponsored story;
identifying interactions with objects by users of the social networking system connected to the viewing user, the interactions identified based on the content identified by the story request;
generating candidate sponsored stories based on the identified interaction, each candidate sponsored story describing an interaction performed by a user of the social networking system who is connected to the viewing user;
ranking the candidate sponsored stories based on a performance metric specified by the story request, the performance metric specifying an objective for the sponsored story unit;
selecting a candidate sponsored story based in part on the ranking;
generating the sponsored story unit including the selected candidate sponsored story; and
presenting the sponsored story unit to the viewing user.

2. The method of claim 1, further comprising:
receiving an interaction with the sponsored story unit from the viewing user;
collecting a performance metric for the sponsored story unit based at least in part on the received interaction; and
storing the performance metric for the sponsored story unit.

3. The method of claim 1, further comprising:
ranking subsequently generated candidate sponsored stories based at least in part on the performance metric.

4. The method of claim 1, wherein the performance metric is selected from a group consisting of: a unique number of users of the social networking system to which the sponsored story unit was presented, a percentage of users of the social networking system to which the sponsored story unit was presented, a number of users of the social networking system interacting with the sponsored story unit, a click-through-rate, an amount of revenue associated with the sponsored story unit, a frequency of interactions with the sponsored story unit by users of the social networking system, and any combination thereof.

5. The method of claim 1, wherein ranking the candidate sponsored stories based on the performance metric specified by the story request comprises:
determining affinities between the viewing user and each candidate sponsored story; and
ranking the candidate sponsored stories based on the affinities.

6. The method of claim 1, wherein ranking the candidate sponsored stories based on the performance metric specified by the story request comprises:
determining affinities between the viewing user and a user described by each candidate sponsored story; and
ranking the candidate sponsored stories based on the affinities.

7. The method of claim 1, wherein ranking the candidate sponsored stories based on the performance metric specified by the story request comprises:
ranking the candidate sponsored stories so candidate sponsored stories describing a type of action specified by the request have a higher position in the ranking

8. The method of claim 1, wherein ranking the candidate sponsored stories based on the performance metric specified by the story request comprises:
ranking the candidate sponsored stories based on a time associated with an interaction described by a candidate sponsored story.

9. The method of claim 1, wherein ranking the candidate sponsored stories based on the performance metric specified by the story request comprises:
ranking the candidate sponsored stories based on a number of user interactions with an object described by each candidate sponsored story.

10. The method of claim 1, wherein the objective for the sponsored story unit is selected from a group consisting of: maximizing a number of users of the social networking system presented with the sponsored story unit, maximizing a percentage of users of the social networking system presented with the sponsored story unit, maximizing a number of interactions with the sponsored story unit, maximizing a frequency of interaction with the sponsored story unit, maximizing revenue for an advertiser associated with the sponsored story unit, and any combination thereof.

11. A method comprising:
storing, in a social networking system, a user profile associated with a viewing user, the user profile identifying one or more users of the social networking system connected to the viewing user;
receiving a story request for a sponsored story unit, the story request identifying content to be included in the requested sponsored story;
identifying interactions with objects by users of the social networking system connected to the viewing user, the interactions identified based on the content identified by the story request;
generating candidate sponsored stories based on the identified interaction, each candidate sponsored story describing an interaction performed by a user of the social networking system who is connected to the viewing user;
ranking the candidate sponsored stories based on an objective specified by the story request and a performance metric based on interactions with previously presented sponsored story units;
selecting a candidate sponsored story based in part on the ranking;
generating the sponsored story unit including the selected candidate sponsored story;
presenting the sponsored story unit to the viewing user; and
modifying the objective based on an interaction with the sponsored story unit.

12. The method of claim 11, wherein the performance metric is selected from a group consisting of: a unique number of users of the social networking system to which the sponsored story unit was presented, a percentage of users of the social networking system to which the sponsored story unit was presented, a number of users of the social networking system interacting with the sponsored story unit, a click-through-rate, an amount of revenue associated with the sponsored story unit, a frequency of interactions with the sponsored story unit by users of the social networking system, and any combination thereof.

13. The method of claim 11, wherein ranking the candidate sponsored stories based on the objective specified by the story request and a performance metric based on interactions with previously presented sponsored story units comprises:
determining affinities between the viewing user and each candidate sponsored story; and
ranking the candidate sponsored stories based on the affinities.

14. The method of claim 11, wherein ranking the candidate sponsored stories based on the objective specified by the story request and a performance metric based on interactions with previously presented sponsored story units comprises:
determining affinities between the viewing user and a user described by each candidate sponsored story; and
ranking the candidate sponsored stories based on the affinities.

15. The method of claim 11, wherein ranking the candidate sponsored stories based on the objective specified by the story request and a performance metric based on interactions with previously presented sponsored story units:
ranking the candidate sponsored stories so candidate sponsored stories describing a type of action specified by the request have a higher position in the ranking
16. The method of claim 11, wherein ranking the candidate sponsored stories based on the objective specified by the story request and a performance metric based on interactions with previously presented sponsored story units:
ranking the candidate sponsored stories based on a time associated with an interaction described by a candidate sponsored story.
